(19) United States
(12) Patent Application Publication
(10) Pub. No.: US 2025/0259442 A1
(43) Pub. Date: Aug. 14, 2025

(54) MULTILOCATION AUGMENTED REALITY

(71) Applicant: PICTORYTALE AS, KRISTIANSAND (NO)

(72) Inventors: Suraj PRABHAKARAN, Aachen (DE); Håkon GUNDERSEN, Oslo (NO); Gokce ATAMAN, Oslo (NO)

(21) Appl. No.: 18/849,393

(22) PCT Filed: Mar. 20, 2023
(86) PCT No.: PCT/NO2023/050062

§ 371 Date: Sep. 20, 2024

(30) Foreign Application Priority Data
Mar. 21, 2022 (NO) 20220341

(51) Int. Cl. G06V 20/20; G06T 7/20; G06T 19/00; G06V 40/10

(52) U.S. Cl. CPC G06V 20/20; G06T 7/20; G06T 19/006; G06V 40/10; G06T 2207/30196; G06T 2219/024

(57) ABSTRACT

A method and corresponding devices for synchronizing simultaneous rendering of the same augmented reality environment at multiple locations. The methods allows a plurality of devices to obtain a camera view of their respective local environments and maintain an augmented reality environment by integrating the camera view and the virtual objects. On at least one of the plurality of devices, information relating to the integration of the virtual object, including any change or interaction, is transmitted to at least one other of the plurality of devices. At the receiving device a corresponding object can be changed or updated in accordance with the received information. In some embodiments the devices are able to generate virtual representations of objects detected in the camera view, for example a person, and enable the other devices to represent and update the object in their respective augmented reality environments.

### TECHNICAL FIELD

The present invention relates to synchronization of augmented reality content between several devices, enabling users that are not located at the same place to experience and interact with the same augmented reality content on their respective devices.

### BACKGROUND

Augmented reality (AR) content is experienced by users by accessing AR content and viewing this content through mobile apps or AR glasses. Normally, each user accesses AR content independently and therefore views and interacts with their own AR content without any other user being able to influence the AR environment. Interaction with AR content on one mobile device by a first user is not reflected on any other user's experience of and interaction with the same AR content on their respective devices. However, shared AR is a concept where multiple users view the same AR content from multiple devices at the same time. That is, users are not viewing their own instances of the AR content through their devices, but they are experiencing the same, only instance of the AR content viewed through their respective devices. Stretching this further is multiplayer AR, which allows multiple users to not only view but also interact with the same AR content simultaneously.

There are available software development kits (SDKs) that allow developers to create multiplayer AR apps, and such apps are commercially available. However, there are significant limitations associated with the existing technology which is therefore not in widespread use. For example, the latency associated with loading of and interaction with the AR content have to be very small in order to provide users with a satisfactory experience. Other shortcomings are associated with the way actual and virtual elements overlap to create a seamless AR environment. For example, since the part of an AR scene that represents actual reality will be different at different locations it may be desirable to represent an object that is part of the actual environment at one location but not on another location as a virtual object at the other location. There is a need for new solutions that address these needs in order to create more satisfactory AR user experiences in a manner that is synchronized between multiple locations.

### SUMMARY OF THE DISCLOSURE

The needs outlined above are addressed by a method of synchronizing simultaneous renderings of the same augmented reality environment at multiple locations. According to the method, a camera view of a local environment is obtained. A predefined type of object is detected in the camera view of the local environment and a virtual representation of the detected object is generated. An augmented reality environment is maintained by integrating the camera view of the local environment with the generated virtual representation of the detected object. The generated virtual representation of the detected object and information relating to the integration of the virtual object is transmitted to at least one other device, thus enabling the other device to make a corresponding augmented reality environment based on its local camera view and a corresponding integration of a virtual object.

The information relating to the integration of the virtual object may include information describing a change in at least one of a position and an orientation of the virtual object.

On the at least one of the plurality of devices a predefined type of object in the camera view of the local environment may be detected and a virtual representation of the detected object may be generated. This virtual representation may be transmitted to at least one other of the plurality of devices thus enabling the other device to integrate virtual objects that correspond with real objects in the environment of the first device.

The predefined type of object may in some embodiments be a person, and information relating to the integration of the virtual representation of the person may include a description of movement performed by the person.

Information transmitted to the at least one other device may be used by the at least one other device to integrate or change an integration of a corresponding virtual object and a camera view of a local environment.

Information from the at least one device may, in some embodiments, be transmitted to a server which is configured to forward the received information to at least one other device. Processing of information relating to detection of objects, of movements, of interaction and so on, may be performed locally, or to some extent by a recipient, or by an intermediary server or device in the cloud or edge. Thus, information relating to generation or updating of information may be distributed between the at least one device, a server, and the at least one other device.

A device according to the invention may include modules and functionalities configured to maintain a description of an augmented reality environment by obtaining a camera view of a local environment, detecting a predefined type of object in the camera view of the local environment, generating a virtual representation of the detected object, integrating the camera view of the local environment and the generated virtual representation of the detected object. Such a device will further be able to transmit the generated virtual representation of the detected object and information relating to its integration into the augmented reality environment to at least one other device. Such a device may further be configured to receive information relating to the integration of the virtual object from the at least one other device, and update the augmented reality environment in accordance with the received information.

### BRIEF DESCRIPTION OF THE DRAWINGS

The invention will now be described in further detail with reference to the drawings, where:

FIG. 1 shows a system which may be configured to operate in accordance with the invention; and

FIG. 2 is a block diagram showing modules in devices according to an embodiment of the invention.

### DETAILED DESCRIPTION

The present invention introduces a new multilocation AR, which provides the technology and tools that allow multiple users at different locations to interact with the same AR content simultaneously in an immersive way.

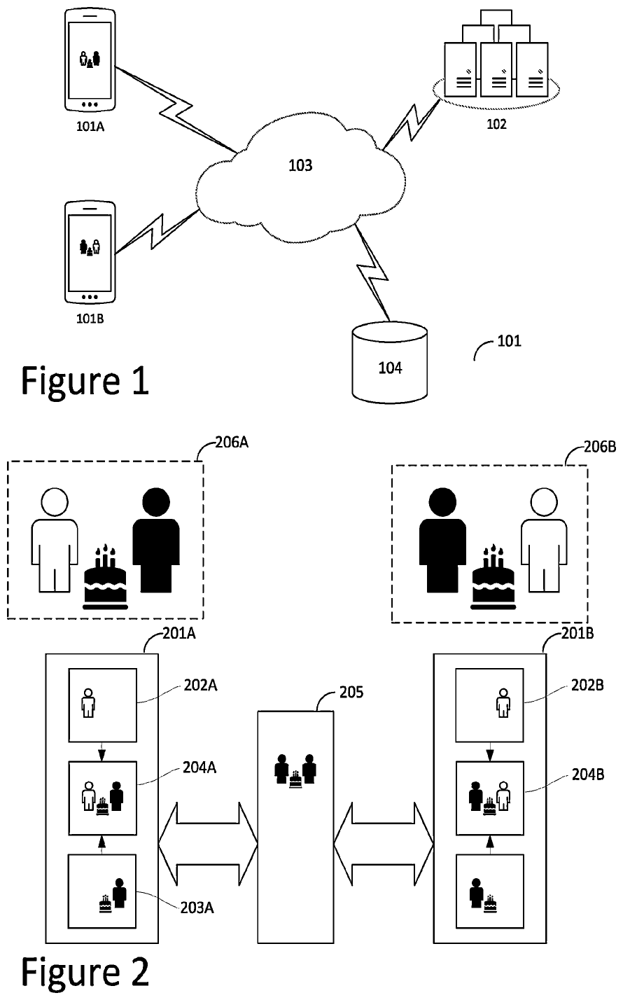

FIG. 1 shows a system configured for multilocation AR in accordance with the present invention. Multilocation AR functionality is provided by mobile AR apps installed on mobile devices 101 and configured to synchronize AR content with a multilocation AR backend 102 with a multilocation AR controller, or with other devices 101 running mobile AR apps with similar functionality.

A multilocation AR controller may be hosted in the cloud 103 or the edge and provides the tools and methods that allow establishing the necessary connection between devices.

This system allows users at different locations to access the same AR object or the AR environment and at the same time experience each other's immersion. For example, if two users located at two different locations have loaded the same AR content and view the same object on their respective mobile devices 101, the following will be enabled.

First, object synchronization will ensure that the object is synchronized in all the participating AR devices 101. This means that when the first user interacts with the object and thus changes its state on his or her device 101A, the new state is communicated to the other device 101B and the state is correspondingly changed there to update the view the second user has of the same object. According to an aspect of the present invention, multilocation AR includes an AR format that enables tracking of a number of parameters associated with an AR object such that it becomes possible not only to track position and orientation, but also features associated with lighting, position relative to other objects, and more.

Secondly, scene synchronization provides improved immersion. When an object shared between two or more users is synchronized they will appear in a consistent manner on all devices. If one of the users now brings himself or some real object into the AR scene this will be reflected in the other users' camera view. That is, user A can stand in front of the camera on his mobile device 101A and in a position that is adjacent to the virtual object. The camera on user A's mobile device 101A will capture the real part of the AR scene including the user, and simultaneously the state of the virtual AR object will be recorded. Functionality provided by the present invention includes a detection algorithm configured to detect specific objects. Embodiments of the invention may be configured to detect different types of objects, but the exemplary embodiments described herein will focus on detection of humans. However, other embodiments may be configured to detect other types of objects, for example automobiles, gaming pieces, boxing gloves, etc.

The human detection algorithm may be configured to detect aspects of the human body, for example the position of joints, depth sensing information, and more. This information may be transferred to user B's device 101B. User B's device 101B may then render an AR version of the human body detected in the camera view of the remote device 101A and placing it next to the virtual object in accordance with state information received from the remote mobile device 101A regarding both the human body's position in the scene as determined by the human detection algorithm and the position of the virtual AR object. Thus, the view of the AR scene provided on user B's device 101B is the same as that presented on user A's device 101A with except for the fact that on the first device 101A the human body is displayed as it is captured by the device camera, while on the second device 101B the human body is shown as a virtual AR body. Similarly, if a human enters the scene captured by the camera on user B's mobile device 101B, user A's device will render the scene but with the human captured by user B's device 101B rendered as a virtual AR object.

FIG. 1 also shows a database 104 which may be a repository of AR content.

Reference is now made to FIG. 2 for a more detailed discussion of the various modules included in a system operating in accordance with the invention. This example includes two mobile devices 101, but embodiments of the invention may be configured to include several devices. There is no loss of generality in the two device description and those with skill in the art will readily understand how the invention may be configured for additional devices.

On a first mobile device 101A a first multilocation AR app 201A is installed. This AR app 201A includes camera module 202A which is configured to access, control, and obtain images from a camera that is part of the device 101A. The multilocation AR app 201A also includes a multilocation AR module 203A which receives virtual AR objects from remote devices, as will be described in further detail below. The real environment as captured by the camera module 202A and the virtual objects provided by the multilocation AR module 203A are combined in an AR content integration module 204A. The virtual AR content received by the integration module 204A includes metadata which describes position and orientation of the virtual objects in the AR environment. This description may be absolute, relative to other objects, or determined by features detected in the scene received by the camera module 202A, for example based on surface detection or image recognition techniques.

In the example illustrated in FIG. 2 the camera module 202A of the first device 101A captures a scene which includes a person. This person is part of the actual reality in the scene at the location of the first device 101A. In order for this person to be represented in the scene presented by the second device 101B, object recognition is performed, and a virtual representation of the person is generated and transmitted to a multilocation AR controller 205 running on the backend server 102.

A similar process is performed on the second device 101B where the multilocation AR module 201B is running. In this example a second person is present in the real scene and captured by the camera module 202B in the second device 101B. As for the first device, a virtual representation of the second person is generated and transmitted to the AR controller 205 running on the backend server 102.

The backend server may maintain a representation of all the virtual objects in the shared AR environment. In this example that includes the two virtual representations of the real persons as well as a purely virtual object in the form of a cake. In the drawing, virtual objects are represented as all black while real objects are represented as white. In the environment maintained by AR controller all objects are virtual.

In some embodiments the backend may not maintain a representation of virtual objects, but simply act as an intermediary which distributes data to participating devices as soon as the data becomes available but does not keep this data in the form of any stored representation of virtual objects. In other embodiments the information relating to synchronization is sent directly between participating devices in a peer-to-peer manner.

The virtual objects are shared among the participating devices 101. However, objects that are actually present in the local environment does not have to be presented as virtual objects in the local presentation of the AR environment. Therefore, on the first device 101A the multilocation AR module 203A only maintains representations of the virtual objects that are entirely virtual (in this example the cake) or are virtual representations of real objects at a different location (in this example the person captured by the camera module on the remote device). Consequently, the multilocation AR app 201A on the first device 101A, using its AR content integration module 204A generates an AR scene with a representation of the person present as provided by the camera module 202A and virtual representations of the cake and the remote person. This scene is presented by the local device 101A on its display 206A or on connected AR goggles, or some similar device.

The same is the case on the second device 101B, except here it is the other person that is presented as captured by the camera and provided by the camera module 202B, while the cake and the first person are given virtual representations.

Various techniques such as surface detection, object recognition, and the like may be used but will not be described in detail herein since they are well known in the art.

The actual sharing of an AR environment can be facilitated in a number of ways that are known in the art and that are not specific to augmented reality. For example, a unique QR code or link that is shared by one user to another through a message, or in apps that consist of a friend's list, a user can just invite a friend to share/view the AR content and is then activated. Once the sharing is activated, any AR content is synced with participating users.

When a connection between two or more devices has been established any changes to the objects in the scene or to the scene itself is synchronized. This synchronization is provided as a service by the multilocation AR controller 205. Once multilocation AR sharing has been activated, the synchronization functionality provides synchronization of the states between the objects seen by the users. In the case of object synchronization, the synchronization process uses information rigid body information, shaders, vector positions, etc. to make it possible for objects and the interactions with objects to be synchronized with other devices.

Synchronization of the scene itself is based on object recognition algorithms. Different embodiments may, as already mentioned, be configured to recognize, and synchronize different objects. This example will describe human body recognition, but the principles are similar for detection and recognition of other types of objects.

A human body recognition algorithm detects and tracks the human bodies in the scene. In some embodiments the multilocation AR app 201 detects, tracks, and transfers live data. This means that a human body detected in the image provided by the camera module 202 is tracked and segmentation is performed in near real time. The resulting data is sent to the multilocation AR controller 205 from which it will be distributed to participating devices. (In some embodiments the devices operate in a peer-to-peer mode and the information is sent to the other participating devices directly.) The data transferred to participating devices will typically include vector position information.

The participating devices will, upon receiving incoming tracking data and segmented human data, render this on the display 206 of the receiving device 101. In the process of rendering, the device may apply Gaussian Blur to generate a 3D humanoid and place it appropriately in the scene according to the vector data received. Thus, in this method, processing is done in near real time, only subject to processing and transmission latency.

As an alternative to segmentation being performed on each device, the devices may instead send the tracked human body information to an edge system or to the cloud where the multilocation AR controller 205 is located for processing there. The multilocation AR controller 205 then performs the segmentation and 3D humanoid generation in near real time and forwards the results to the participating devices to be rendered there. In principle, the extent to which tasks are distributed between originating device, backend, rendering device may vary between different embodiments, as those with skill in the art will readily realize.

The synchronization methods described above may provide high accuracy and little loss of data. However, these methods require a relatively high amount of processing load and data amounts and may therefore result in higher battery usage and larger bandwidth requirements due to the larger amounts of data being processed and transferred. In the embodiments where the multilocation AR controller 205 performs the processing this may increase the costs associated with cloud and/or edge processing.

In other embodiments of the invention partial tracking is performed. In embodiments implementing this method, user's may share avatar pictures with other users prior to scene synchronization. Upon activation of the shared AR environment a humanoid version of the respective users' uploaded pictures are already available can be loaded into memory. For example, upon activation of an AR environment shared between users operating device 101A and device 101B, respectively, the first user's device 101A will load the avatar representing the second user, and the second user's device 101B will load the avatar representing the first user. The avatars may be humanoid representations generated from 2D images the users have shared between them. The processing of the 2D images to generate 3D humanoid representations may, in different embodiments be performed by the originating device, by the receiving device, or as a service by the multilocation AR controller 205.

When a user (or any person) enters a scene and is captured by a device camera, the human figure is detected and its position in the scene and its pose may be recognized and transferred to the other device where the 3D humanoid avatar is rendered. When the person moves their movements will be tracked (joints, rotations, etc.) and the tracked motion data is sent to the remote device. The multilocation AR app 201 on the remote device uses the received motion data to animate the representation of the other user which is already rendered on the display of the device. This synchronization method may reduce the amount of data that is transferred between the devices and does not need the AR controller to perform any intermediate processing. The method may therefore reduce battery usage, processing load and bandwidth requirements at the cost of reduced accuracy depending on the accuracy that can be achieved in the capturing of the joints, rotations and other physical body aspects.

The two synchronization methods described herein may, of course, be combined in some embodiment such that the method chosen depends on user configuration, a selection made for a given shared environment, or in dependence of the type of object tracked in a scene.

1. A method of synchronizing simultaneous rendering of the same augmented reality environment at multiple locations, comprising:
obtaining a camera view of a local environment;
detecting a predefined type of object in the camera view of the local environment;
generating a virtual representation of the detected object;
maintaining an augmented reality environment by integrating the camera view of the local environment with the generated virtual representation of the detected object; and
transmitting the generated virtual representation of the detected object and information relating to its integration into the augmented reality environment to the at least one other device.

2. A method according to claim 1, wherein the information relating to the integration of the virtual object includes information describing a change in at least one of a position and an orientation of the virtual object.

3. A method according to claim 1, wherein the predefined type of object is a person.

4. A method according to claim 3, further comprising generating information relating to the integration of the virtual representation of the person, including a description of movement performed by the person.

5. A method according to claim 1, wherein information transmitted to the at least one other device is used by the at least one other device to integrate or change an integration of a corresponding virtual object and a camera view of a local environment.

6. A method according to claim 1, wherein information from at least one device is transmitted to a server which is configured to forward the received information to the at least one other device.

7. A method according to claim 6, where processing of information relating to generation or updating of information is distributed between the at least one device, the server, and the at least one other device.

8. A device configured to maintain a description of an augmented reality environment by:
obtaining a camera view of a local environment;
detecting a predefined type of object in the camera view of the local environment;
generating a virtual representation of the detected object;
integrating the camera view of the local environment and the generated virtual representation of the detected object; and
transmitting the generated virtual representation of the detected object and information relating to its integration into the augmented reality environment to at least one other device.

9. A device according to claim 8, being further configured to: receive information relating to the integration of the virtual object from the at least one other device, and update the augmented reality environment in accordance with the received information.
